(19) United States
(12) Patent Application Publication
(10) Pub. No.: US 2015/0292431 A1
(43) Pub. Date: Oct. 15, 2015

(54) METHOD FOR COMPENSATING POST-INJECTION TIMING

(71) Applicant: Hyundai Motor Company, Seoul (KR)

(72) Inventors: Kihoon NAM, Gunpo-si (KR); Kyoungchan Han, Gunpo-si (KR); MinSu Kim, Hwaseong-si (KR)

(73) Assignee: Hyundai Motor Company, Seoul (KR)

(21) Appl. No.: 14/502,767

(22) Filed: Sep. 30, 2014

(30) Foreign Application Priority Data
Apr. 9, 2014 (KR) 10-2014-0042594

(51) Int. Cl. F02D 41/40; F02D 41/30

(52) U.S. Cl. CPC F02D 41/405; F02D 41/3017

(57) ABSTRACT

A method for compensating post-injection timing may include performing main injection to perform combustion using air drawn into a cylinder, performing post-injection after the main injection to control an amount of reducing agent or to change a temperature of exhaust gas, determining first injection timing of the post-injection according to operation conditions of an engine, advancing or retarding the first injection timing according to combustion efficiency of the post-injection, and performing the post-injection at a compensated first injection timing.

### CROSS-REFERENCE TO RELATED APPLICATION

The present application claims priority to and the benefit of Korean Patent Application No. 10-2014-0042594 filed on Apr. 9, 2014, the entire contents of which is incorporated herein for all purposes by this reference.

### BACKGROUND OF THE INVENTION

1. Field of the Invention

The present invention relates to a method for compensating post-injection timing to effectively supply a reducing agent to an LNT that reduces activation time of a purification system (catalytic device) and reduces nitrogen oxide.

2. Description of Related Art

In general, a diesel engine has excellent economic efficiency compared to a gasoline engine and thus the diesel engine has been applied in various fields, and the application range of the diesel engine is extended to recreational vehicles and passenger vehicles.

In order to apply the diesel engine to a passenger vehicle, the diesel engine requires down-sizing and high speed, but as the diesel engine is down-sized and driven at a high speed, time and space for mixing air and a fuel are reduced, thereby causing difficulty in optimization.

In order to solve such a problem, a common rail injection system has been provided. The common rail injection system controls atomization, injection timing, and injection amount by applying electronization and high-pressure methods to a fuel injection system.

Compared to low-pressure injection using an existing cam driving method, the common rail injection system provides high-pressure injection and precisely controls injection timing, thereby improving fuel efficiency and stabilizing an exhaust gas.

As an injection method, the common rail injection system includes pilot injection, main injection, and post-injection.

The pilot injection performs fuel injection before the main injection is carried out for better combustion of the main injection fuel, suppression of noise generation due to direct injection, reduction of exhaust gas, and stabilization of combustion.

The main injection is carried out to generate a substantial amount of the output of an engine, and the amount of injection is determined according to conditions such as engine torque, engine RPM, coolant temperature, intake air temperature, atmospheric pressure, and the like.

In addition, the post-injection follows the main injection, and the amount of fuel calculated during a period until 200° ATDC in the expansion stroke or exhaust stroke is injected into the exhaust gas.

Unlike the pilot injection or the main injection, the post-injection is evaporated by residual heat of the exhaust gas and recycled to the combustion chamber through an EGR system, thereby performing functions of the pilot injection.

In addition, the post-injection induces activation of a catalyst in the purification system (catalytic device) to suppress generation of nitrogen oxide (NOₓ) and hydrocarbon (HC) exhaust gases.

As described above, in case of the post-injection for activation of the purification system, an additional injection device (i.e., an injector) is mounted or urea injection used in an SCR is used, and the amount of injection is determined according to an engine operation condition and a catalyst temperature.

However, inaccurate determination of the post-injection timing and the amount of injection may cause an increase in fuel consumption, and deterioration of exhaust gas quality may not satisfy exhaust gas regulations.

The information disclosed in this Background of the Invention section is only for enhancement of understanding of the general background of the invention and should not be taken as an acknowledgement or any form of suggestion that this information forms the prior art already known to a person skilled in the art.

### BRIEF SUMMARY

Various aspects of the present invention are directed to providing a method for compensating post-injection timing that improves quality of an exhaust gas and effectively reduces a nitrogen oxide by performing main injection and compensating post-injecting timing after the main injection.

A method for compensating post-injection timing may include performing main injection to perform combustion using air drawn into a cylinder, performing post-injection after the main injection to control an amount of reducing agent or to change a temperature of exhaust gas, determining first injection timing of the post-injection according to operation conditions of an engine, advancing or retarding the first injection timing according to combustion efficiency of the post-injection, and performing the post-injection at a compensated first injection timing.

The post-injection is performed to increase the amount of reducing agent that reduces nitrogen oxide or increase a temperature of the exhaust gas.

The operation conditions may include a rotation speed of the engine and an amount of fuel injection of the post-injection.

The combustion efficiency of the post-injection is determined using an amount of post-injection fuel and an amount of heat generation.

The amount of post-injection fuel is selected from a predetermined map table according to the operation conditions.

The amount of heat generation is determined by a pressure change sensed by a pressure sensor.

The amount of heat generation is determined by dQ/dθ=(K/κ−1) P dV/dθ+(1/κ−1) V dP/dθ, wherein the P is cylinder internal pressure, the V is cylinder volume, the θ is engine rotation angle, the κ is specific heat ratio, the Q is amount of heat, and the dQ/dθ is rate of heat release, the amount of heat generation per unit angle, and heat generation rate.

The operation conditions may include a temperature of a coolant.

The post-injection may include first post-injection performed after the main injection and second post-injection performed after the first post-injection.

When a heat efficiency of the post-injection is determined to be higher than a predetermined level, the first post-injection timing of the post-injection is retarded.

When a heat efficiency of the post-injection is determined to be lower than a predetermined level, the first post-injection timing is advanced.

An engine system for compensating the post-injection timing may include an injector provided to inject a fuel into a combustion chamber of a cylinder, and a controller performing the above-mentioned method.

The method for compensating post-injecting timing according to the present invention compensates post-injection timing according to combustion efficiency of post-injection so that quality of the exhaust gas can be improved and the reducing agent can be stably supplied, thereby effectively eliminating the nitrogen oxide.

The methods and apparatuses of the present invention have other features and advantages which will be apparent from or are set forth in more detail in the accompanying drawings, which are incorporated herein, and the following Detailed Description, which together serve to explain certain principles of the present invention.

### BRIEF DESCRIPTION OF THE DRAWINGS

FIG. 1 is a schematic diagram of a system that compensates post-injection timing according to an exemplary embodiment of the present invention.

FIG. 2 is a flowchart of a method for compensating the post-injection timing according to the exemplary embodiment of the present invention.

FIG. 3 is a graph illustrating the amount of heat generation in the method that compensates the post-injection timing according to the exemplary embodiment of the present invention.

FIGS. 4A, 4B, and 4C are graphs respectively illustrating data for performing the method that compensates the post-injection timing according to the exemplary embodiment of the present invention.

It should be understood that the appended drawings are not necessarily to scale, presenting a somewhat simplified representation of various features illustrative of the basic principles of the invention. The specific design features of the present invention as disclosed herein, including, for example, specific dimensions, orientations, locations, and shapes will be determined in part by the particular intended application and use environment.

In the figures, reference numbers refer to the same or equivalent parts of the present invention throughout the several figures of the drawing.

### DETAILED DESCRIPTION

Reference will now be made in detail to various embodiments of the present invention(s), examples of which are illustrated in the accompanying drawings and described below. While the invention(s) will be described in conjunction with exemplary embodiments, it will be understood that the present description is not intended to limit the invention(s) to those exemplary embodiments. On the contrary, the invention(s) is/are intended to cover not only the exemplary embodiments, but also various alternatives, modifications, equivalents and other embodiments, which may be included within the spirit and scope of the invention as defined by the appended claims.

An exemplary embodiment of the present invention will hereinafter be described in detail with reference to the accompanying drawings.

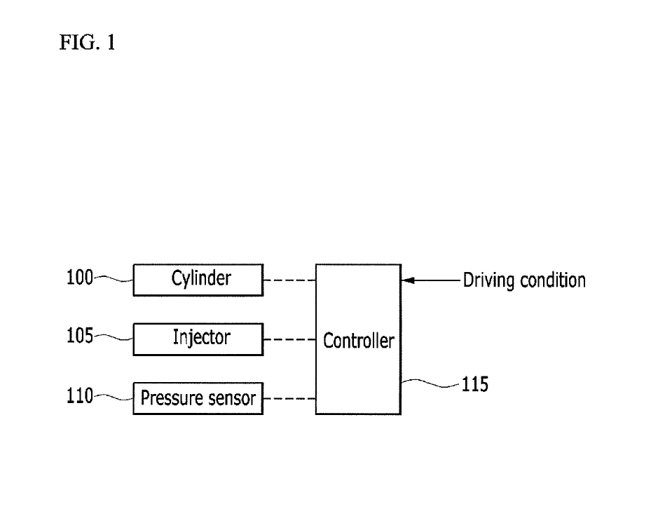

FIG. 1 is a schematic diagram of a system that compensates post-injection timing according to an exemplary embodiment of the present invention.

Referring to FIG. 1, a system that post-injection timing includes a cylinder 100, an injector 105, a pressure sensor 110, and a control portion 115.

The cylinder 100 forms a combustion chamber, the injector 105 is disposed to inject a fuel into the cylinder 100, and the pressure sensor 110 is disposed to sense internal pressure of the cylinder 100.

The control portion 115 controls the injector 105 based on data stored in a map according to an operation condition so as to inject a predetermined amount of fuel into the cylinder 100.

The injection performed by the injector 105 includes main injection, pilot injection performed before the main injection, and post-injection performed after the main injection.

In the exemplary embodiment of the present invention, a lean NO trap (LNT) is provided in an exhaust line through which exhaust gas combusted in the cylinder 100 is exhausted, and the nitrogen oxide purification catalyst traps nitrogen oxide in a low reducing agent state and reduces the nitrogen oxide in a state of being enriched with a reducing agent to eliminate the nitrogen oxide.

The injector controls the amount of reducing agent in the exhaust gas through the post-injection to thereby control the exhaust gas in the reducing agent enrichment state. In addition, the nitrogen oxide in the exhaust gas combusted in the cylinder 100 is eliminated through the lean NO trap (LNT) of the exhaust line and then the exhaust gas is emitted to the outside.

The control portion 115 determines regeneration of the LNT through a nitrogen oxide sensor, and when the regeneration is determined, the control portion 115 performs the post-injection at a set timing by controlling the injector 105.

When the post-injection is performed, the amount of fuel and the injection timing of the post-injection are predetermined according to an operation condition. Thus, the control portion 115 selects the amount of fuel injection and injection timing for the post-injection from stored data according to the operation condition.

In the exemplary embodiment of the present invention, the amount of fuel and the injection timing of the post-injection are predetermined by rotation speed of the engine and an injection amount map.

In addition, the injection timing of the post-injection is compensated by being advanced or retarded according to a combustion efficiency of the post-injection. The combustion efficiency of the post-injection is determined by the amount of fuel of the post-injection and the amount of heat generation.

The amount of fuel of the post-injection is a predetermined value, and the heat generation may be calculated by pressure variation sensed by the pressure sensor 110 and predetermined volume variation of the combustion chamber.

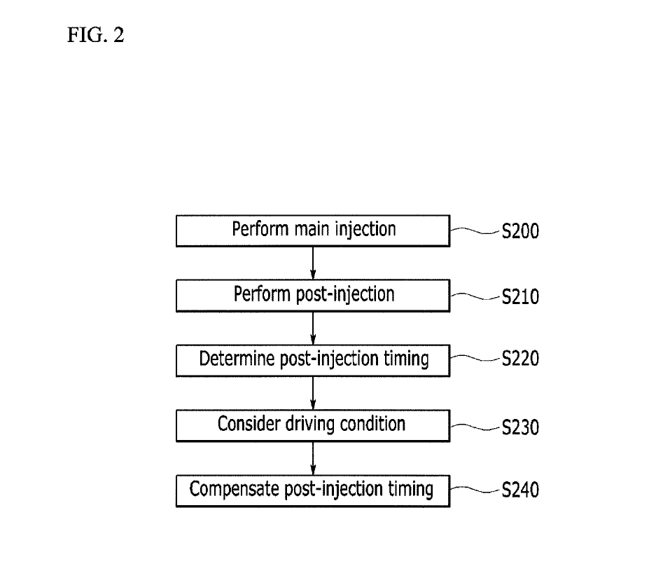

FIG. 2 is a flowchart of a method for compensating the post-injection timing according to the exemplary embodiment of the present invention.

Referring to FIG. 2, the controller 115 controls the injector 105 to perform the main injection in S200, and controls the injector 105 to perform the post-injection in S210.

A condition for the injector 105 to perform the post-injection may include regeneration of the LNT and a condition that increases a temperature of the exhaust gas flowing in the LNT.

In S220, the control portion 115 selects or determines the main injection timing and the post-injection timing of the injector 105 based on operation conditions. Here, the operation conditions may include combustion efficiency, rotation speed, coolant temperature, intake air temperature, intake amount, accelerator pedal operation amount, demand torque, and the like.

In S230, the control portion 115 calculates/selects the post-injection timing according to the operation conditions, and compensates the injection timing of the post-injection in S240.

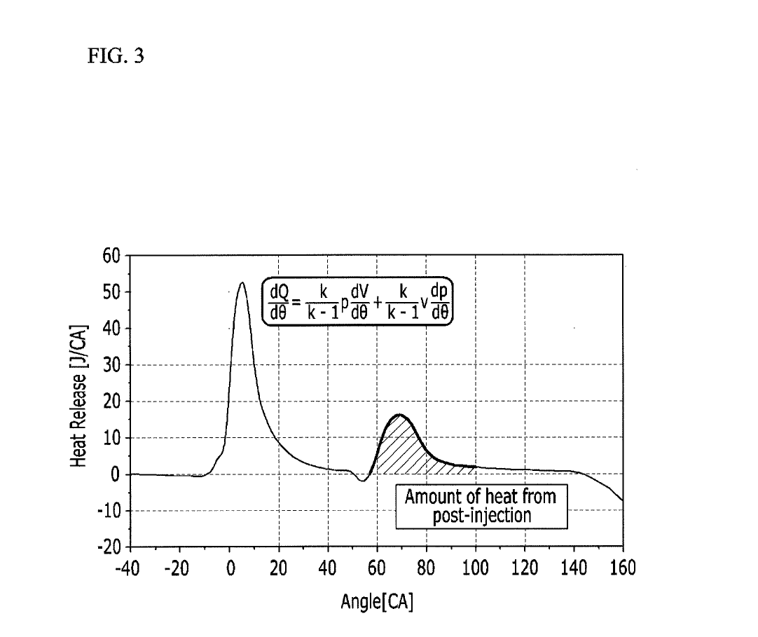

FIG. 3 is a graph illustrating the amount of heat generation in the method for compensating the post-injection timing according to the exemplary embodiment of the present invention.

Referring to FIG. 3, the horizontal axis represents a rotation angle of a crankshaft and the vertical axis represents the amount of heat generation.

dQ/dθ=(κ/κ−1)PdV/dθ+(1/κ−1)VdP/dθ [Equation]

Here, P is cylinder internal pressure, V is cylinder volume, θ is engine rotation angle, κ is specific heat ratio (specific heat at constant pressure/specific heat at constant volume), Q is amount of heat, and dQ/dθ is rate of heat release, amount of heat generation per unit angle, and heat generation rate.

The amount of heat generation is calculated as given in the above equation, and the pressure and the pressure variation are sensed by the pressure sensor 110 while the volume may be calculated from the map data or the rotation angle.

In the exemplary embodiment of the present invention, the control portion 115 calculates the combustion efficiency of the post-injection from a predetermined amount of fuel of the post-injection and the amount of heat generation, and the post-injection timing is compensated according to the combustion efficiency.

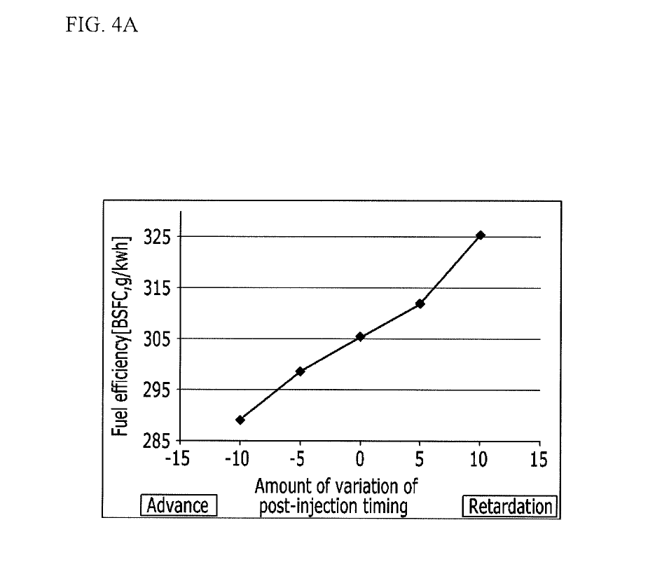

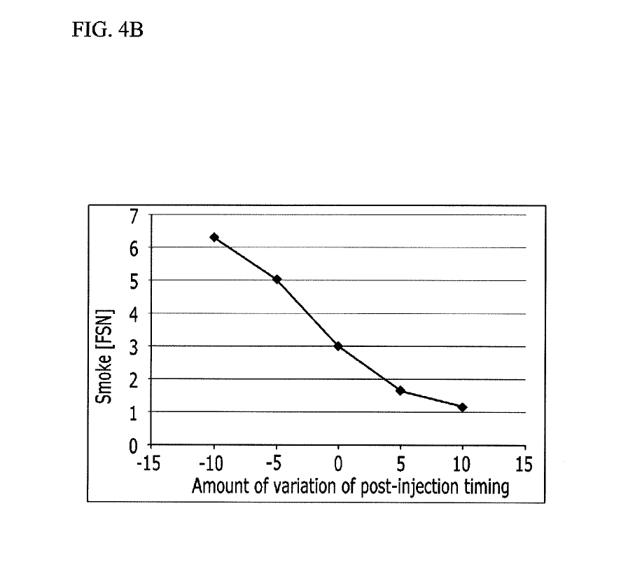

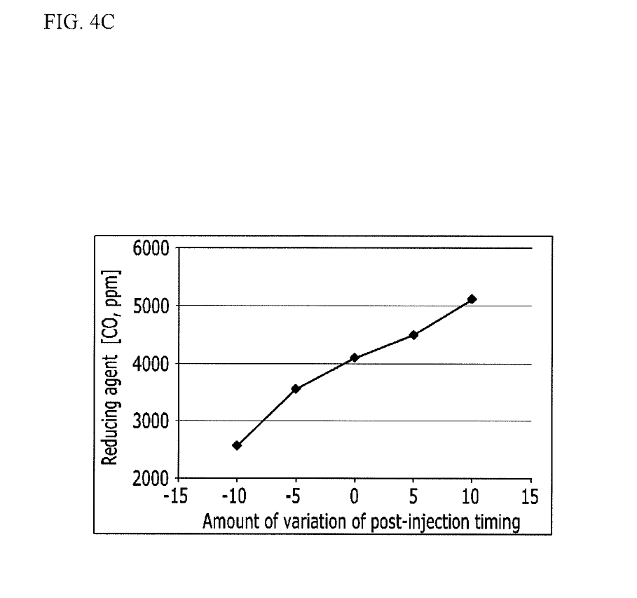

FIGS. 4A, 4B, and 4C are graphs illustrating data for performing the method for compensation the post-injection timing according to the exemplary embodiment of the present invention.

Referring to FIG. 4A, the horizontal axis denotes the post-injection timing with reference to reference injection timing, and the vertical axis denotes fuel efficiency.

As shown in the drawing, it can be observed that the fuel efficiency is changed as the post-injection timing is advanced or retarded from the reference injection timing.

Referring to FIG. 4B, the horizontal axis denotes the post-injection timing with reference to the reference injection timing and the vertical axis denotes the amount of smoke. As shown in the drawing, it can be observed that the amount of smoke (particulate materials) is changed as the post-injection timing is advanced or retarded from the reference injection timing.

Referring to FIG. 4C, the horizontal axis denotes the post-injection timing with reference to the reference injection timing and the vertical axis denotes the amount of reducing agent.

As shown in the drawing, it can be observed that the amount of reducing agent is changed as the post-injection timing is advanced or retarded from the reference injection timing.

The foregoing descriptions of specific exemplary embodiments of the present invention have been presented for purposes of illustration and description. They are not intended to be exhaustive or to limit the invention to the precise forms disclosed, and obviously many modifications and variations are possible in light of the above teachings. The exemplary embodiments were chosen and described in order to explain certain principles of the invention and their practical application, to thereby enable others skilled in the art to make and utilize various exemplary embodiments of the present invention, as well as various alternatives and modifications thereof. It is intended that the scope of the invention be defined by the Claims appended hereto and their equivalents.

What is claimed is:

1. A method for compensating post-injection timing, comprising:
performing main injection to perform combustion using air drawn into a cylinder;
performing post-injection after the main injection to control an amount of reducing agent or to change a temperature of exhaust gas;
determining first injection timing of the post-injection according to operation conditions of an engine;
advancing or retarding the first injection timing according to combustion efficiency of the post-injection; and
performing the post-injection at a compensated first injection timing.

2. The method of claim 1, wherein the post-injection is performed to increase the amount of reducing agent that reduces nitrogen oxide or increase a temperature of the exhaust gas.

3. The method of claim 1, wherein the operation conditions comprise a rotation speed of the engine and an amount of fuel injection of the post-injection.

4. The method of claim 1, wherein the combustion efficiency of the post-injection is determined using an amount of post-injection fuel and an amount of heat generation.

5. The method of claim 4, wherein the amount of post-injection fuel is selected from a predetermined map table according to the operation conditions.

6. The method of claim 4, wherein the amount of heat generation is determined by a pressure change sensed by a pressure sensor.

7. The method of claim 6, wherein the amount of heat generation is determined by dQ/dθ=(κ/κ−1) P dV/dθ+(1/κ−1) V dP/dθ, wherein the P is cylinder internal pressure, the V is cylinder volume, the 0 is engine rotation angle, the κ is specific heat ratio, the Q is amount of heat, and the dQ/dθ is rate of heat release, the amount of heat generation per unit angle, and heat generation rate.

8. The method of claim 1, wherein the operation conditions include a temperature of a coolant.

9. The method of claim 1, wherein the post-injection comprises first post-injection performed after the main injection and second post-injection performed after the first post-injection.

10. The method of claim 9, wherein, when a heat efficiency of the post-injection is determined to be higher than a predetermined level, the first post-injection timing of the post-injection is retarded.

11. The method of claim 9, wherein, when a heat efficiency of the post-injection is determined to be lower than a predetermined level, the first post-injection timing is advanced.

12. An engine system for compensating the post-injection timing, comprising:
an injector provided to inject a fuel into a combustion chamber of a cylinder; and
a controller performing the method of claim 1.
